(19) United States
(12) Patent Application Publication
(10) Pub. No.: US 2018/0322305 A1
(43) Pub. Date: Nov. 8, 2018

(54) SYSTEM AND METHOD FOR DATA THEFT PREVENTION

(71) Applicant: MASTERCARD INTERNATIONAL INCORPORATED, Purchase, NY (US)

(72) Inventor: Alan Gorenstein, Fairfield, CT (US)

(21) Appl. No.: 15/588,341

(22) Filed: May 5, 2017

(51) Int. Cl. G06F 21/62; G06F 21/56; H04L 29/06

(52) U.S. Cl. CPC G06F 21/6245; H04L 63/1425; G06F 21/566; G06F 21/562

(57) ABSTRACT

Data theft may be prevented by modifying a data storage device having standard data records to include “mine” data records. The mine data records may include executable code that when executed implement a breach action that destroys the data records and/or external storage devices in some manner. The mine data records may be recorded in a data decoder. Should an authorized user desire to access the data storage device, an authorizer may provide (or have previously provided) the authorized user with instructions identifying the mine data record locations based on the data decoder.

### BACKGROUND

As society continually relies upon digital devices such as phones, computers, tablets, laptops, etc., an exponential amount of digital data is produced. Some of these data are in the form of digital records which include, e.g., sensitive information about individuals. As digital records are generated, an increasing amount of malware is also developed and implemented in an attempt to fraudulently gain access to and steal these digital records. However, there exists a need to not just stop a fraudulent data breach from occurring, but also counter a successful data breach, thereby maintaining data security and preventing data theft even if a breach occurs.

### SUMMARY

Data theft may be prevented by modifying a data storage device to include mine data records. For example, the data storage device may include protected data in the form of standard and mine data records. The mine data records may include executable code that, when executed, implements a breach action that destroys data (e.g., the data in the standard data records) in the data storage device, destroys the data on an external device once downloaded to that device, and/or facilitates the destruction of the external device to which the data was downloaded. The location of the mine data records may be recorded in a data decoder. Should an authorized user desire to access the data storage device, an authorizer may provide the authorized user with instructions identifying the mine data record locations based on the data decoder. In this way, embodiments herein may prevent data theft even if a data storage device is compromised.

In embodiments, a system for data theft prevention may include a data decoder, communicably coupled to a database having protected data therein, identifying mine data locations within the database, and executable code being stored within the database at the mine data locations. The system may include a network interface configured to provide access to the database from outside the database. The system may further include an authorizer responsive to a data request from a user device received via the network interface and configured to: verify the user device as an authorized user device, and when the data request is an authorized user device, instruct the authorized user device to avoid the mine data locations identified within the data decoder.

In embodiments, a method for data theft prevention includes storing protected data on a data storage device. The method may include inserting executable code within the protected data at a plurality of mine data locations. The method may include generating a data decoder indicating the plurality of mine data locations. The method may include instructing an authorized user device requesting access to the protected data about the mine data locations such that when the authorized user device accesses the data storage device the authorized user device avoids the executable code.

In embodiments, data storage device may include: protected data including a plurality of mine data records and a plurality of standard data records. The data storage device may include executable code located at the plurality of mine data records that when executed implement a breach action. Locations of the plurality of mine data records may be recorded in a data decoder accessible by an authorized user to prevent access of the executable code by the authorized user.

### BRIEF DESCRIPTION OF THE FIGURES

FIG. 1 depicts a system for data theft prevention, in embodiments.

FIG. 2 depicts an example of protected data having a plurality of mine data records and standard data records, in embodiments.

FIG. 3 depicts a data decoder, in embodiments.

FIG. 4 depicts a method for data theft prevention, in embodiments.

### DETAILED DESCRIPTION OF THE EMBODIMENTS

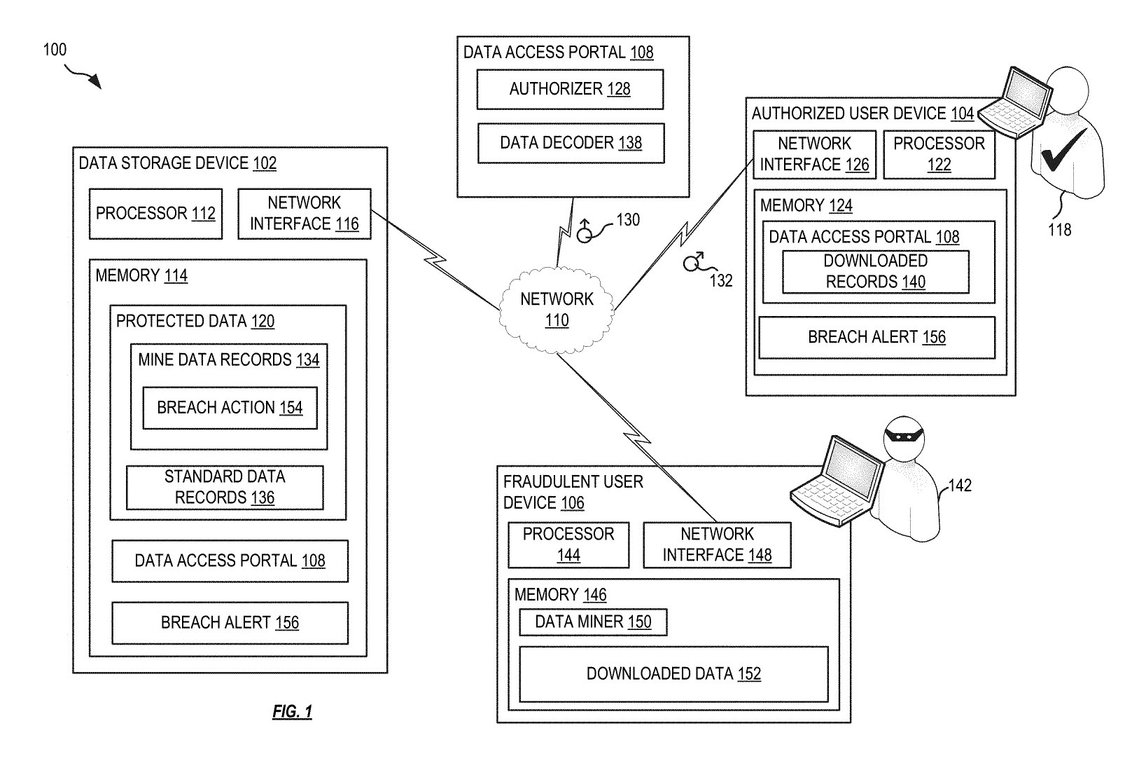

FIG. 1 depicts a system 100 for data theft prevention, in embodiments. System 100 may include one or more of a data storage device 102, an authorized user device 104, a fraudulent user device 106, and a data access portal 108, each of which are described below. Each of data storage device 102, authorized user device 104, fraudulent user device 106, and/or a data access portal 108 may be interconnected, via wireless or via wired connection (as discussed below), via network 110.

Data storage device 102 may be part of, or separate from network 110. Data storage device 102, for example, may provide remote or local storage of data and be implemented as one or more computer servers. Data storage device 102 may include a processor 112 in communication with a memory 114 and a network interface 116. Processor 112 may be any one or more computing device(s) capable of executing computer readable instructions. Memory 114 may be transitory and/or non-transitory, and capable of storing computer readable instructions and/or other data as discussed in further detail below. Memory 114 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory.

Data storage device 102 may be accessible via network interface 116. Network interface 116 may be 1) a wired communication protocol, such as telephone, Ethernet, fiber optics, Cable, USB, lighting cable, or other wired communication protocols, 2) a wireless communication protocol, such as WiFi, cellular 2G, 3G, 4G, 5G, LTE, or other wireless communication protocols, or 3) a combination of wired and wireless communication protocols. Data storage device 102 may be accessible, via network interface 116, by one or more of authorized user device 104, or fraudulent user device 106 via network 110. For example, an authorized user 118 may interact with authorized user device 104 to obtain data stored at data storage device 102, as discussed in further detail below.

Memory 114 may store protected data 120. Protected data 120 may include any type of information that is a target for theft. For example, protected data 120 may include personal information, transaction information, financial information (such as bank account, credit card, etc.), contact information, and any other information about a given user within (or external to) system 100. In embodiments, protected data 120 includes information associated within a payment network, such as a three party payment scheme (e.g. an American Express® payment network) or a four party payment scheme (e.g. MasterCard® and Visa®).

In embodiments, authorized user 118 may gain access to data storage device 102 via data access portal 108. Data access portal 108, in embodiments, may be accessible only by authorized user devices 104. For example, data access portal 108 may be part of an employee intranet, or other protected system that is accessible by users having a threshold amount of credentials. As such, data access portal 108 is shown in FIG. 1 according to a variety of embodiments. For example, in embodiments, data access portal 108, including all features thereof discussed herein, may be located in memory 114. As another example, data access portal 108, including all features thereof discussed herein, may be located on authorized user device 104. As another example, data access portal 108, including all features thereof discussed herein, may be a web-based portal that is connected to data storage device 102 and authorized user device 104 via network 110.

Authorized user 118 may interact within system 100 via authorized user device 104. Authorized user device 104 may include a processor 122 in communication with a memory 124 and a network interface 126.

Processor 122 may be any one or more computing device(s) capable of executing computer readable instructions, for example, stored in memory 124.

Memory 124 may be transitory and/or non-transitory, and capable of storing computer readable instructions and/or other data as discussed in further detail below. Memory 124 may include one or both of volatile (e.g. RAM, DRAM, SRAM, etc.) and non-volatile (e.g. ROM, PROM, EEPROM, NVRAM, flash memory, solid-state storage, optical or hard disk drives, etc.) memory.

Network interface 126 may be 1) a wired communication protocol, such as telephone, Ethernet, fiber optics, Cable, USB, lighting cable, or other wired communication protocols, 2) a wireless communication protocol, such as WiFi, cellular 2G, 3G, 4G, 5G, LTE, or other wireless communication protocols, or 3) a combination of wired and wireless communication protocols.

Data access portal 108 may include transitory and/or non-transitory computer readable instructions that, when executed by a processor (which may be processor 112, processor 122, or any other processor, such as one or more associated with network 110) operate as an interface between authorized user 118 and data storage device 102. For example, data access portal 108 may include an authorizer 128, implemented by said computer readable instructions, that analyzes a received data access request 130 from authorized user device 104. Authorizer 128, in response to receipt of the data access request 130 (or in response to the event of the establishment and authentication of a newly approved data user), may then transmit instructions 132 to authorized user device 104 identifying access parameters required to safely access protected data 120.

Instructions 132 to avoid the mine data locations may be managed outside of the data request/access process. As an example, instructions 132 may be provided to authorized user 118 at the time their original corporate credentials are granted. Instructions 132 to avoid the mine data may be managed off-line and may be, e.g., managed on-line via secure and encrypted communications and sent only to restricted (for example, within corporate firewall) IP domains. As such, instructions 132 may be communicated, e.g., in an electronic format, and that the access to these instructions 132 may follow a separate protocol and process different from the protocol, time and process used to actually access the protected data 120. This may avoid the potential to simply breach the decoder 138 at the time data storage device 102 is breached.

Data access request 130 may be generated by authorized user device 104 via interaction with authorized user 118. Authorized user 118 may desire to obtain a certain range of records within protected data 120. As an example using credit cards, data access request 130 may be a request to obtain data within protected data 120 on all cards within a range of card numbers. As another example, data access request 130 may be a request to obtain data within protected data 120 on all cards associated with a given geographical region. It should be appreciated that any type or format of query could be implemented within data access request 130, and that the format of the query may change based on the type of data being requested.

In embodiments, this intermediate process (including sending of data access request 130 and receipt of instructions 132) may be utilized within system 100 when protected data 120 may include mine data records 134 as well as standard data records 136. Mine data records 134 may include malware stored within protected data such that if the protected data 120 is fraudulently obtained, the malware is automatically executed. The phrase “malware,” as used with reference to embodiments discussed, may include a variety of code and activities. For example, malware may include, but is not limited to, “Trojan” which has infection methods and a wide variety of manifestations, or “PUP” which can be self-installing (sometimes as a browser help object), and may (for example) collect/intercept personal and server information, alter DNS settings and redirect traffic and connections to websites that contain extensive additional (malware) executable code; In embodiments, the malware may implement one or more of the following breach actions 154: erase (or close down) the data that was obtained, erase the database where the data was originally stored (e.g. memory 114), destroy the device obtaining the data fraudulently, direct a fraudulent user to websites including extensive malware code, or some other data destruction process.

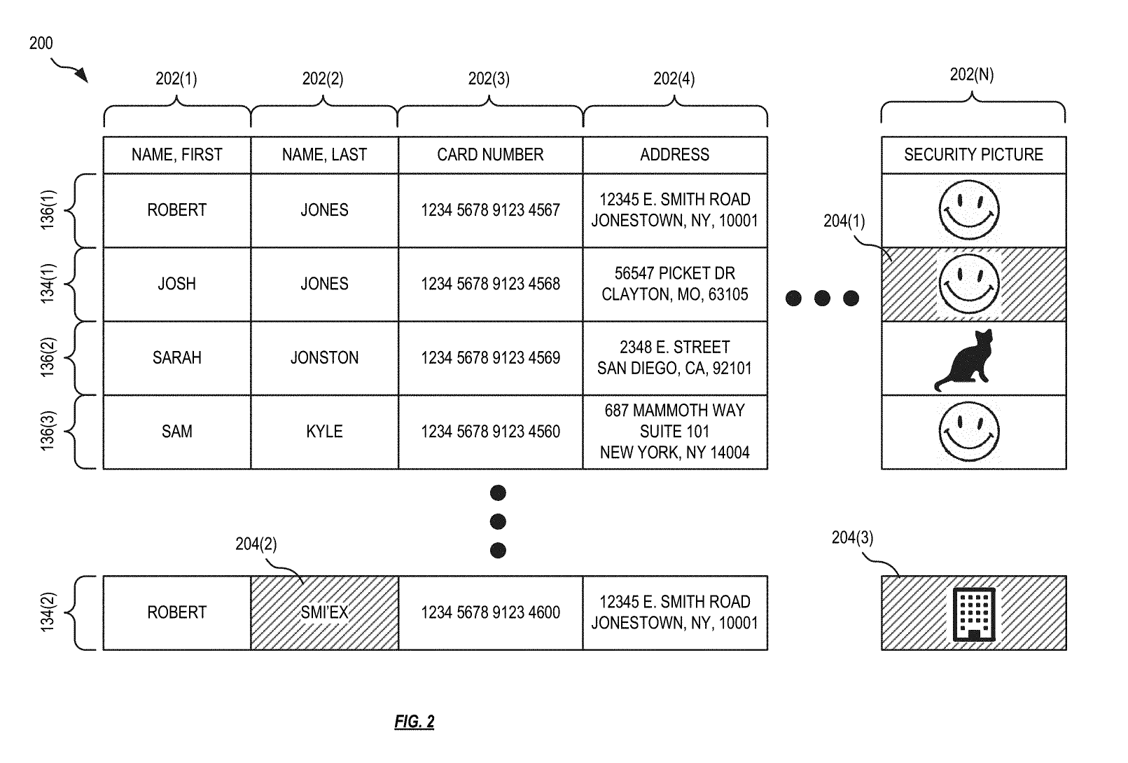

FIG. 2 depicts protected data 200, which is an example of protected data 120 of FIG. 1, having a plurality of mine data records 134 and standard data records 136, in embodiments. Protected data 200 is shown as a table, but it should be appreciated that protected data 200 may be in the format of any database, and may include records/data of any type. Protected data 200, for example, includes a plurality of data categories 202(1)-202(N). Protected data 200 is shown having two mine data records 134(1), 134(2) that include malware mines at locations 204(1), 204(2), and 204(3). Malware locations 204(2) and 204(3) (e.g. mine data record locations) are shown in the same mine data record 134(2), for example, in the same row of the table. It should be appreciated that any number of malware locations 204 may be included without departing from the scope hereof, and that each individual location 204 may be a single mine data record 134 (e.g. the mine data record 134 need not be a “row” but can be a single or multiple data entry within protected data 120, or a column, or other data entry format).

Moreover, locations 204 may include text and/or image entries within protected data 120. In embodiments, mine data records 134 are generated randomly. In embodiments, mine data records 134 are located at mathematically random locations (i.e. locations that appear completely random, but in fact are mathematically generated such as using the SAS Ranuni, Rannor, Ranbin, Ranpoi function and the location thereof may be identified based on knowledge of the function parameters).

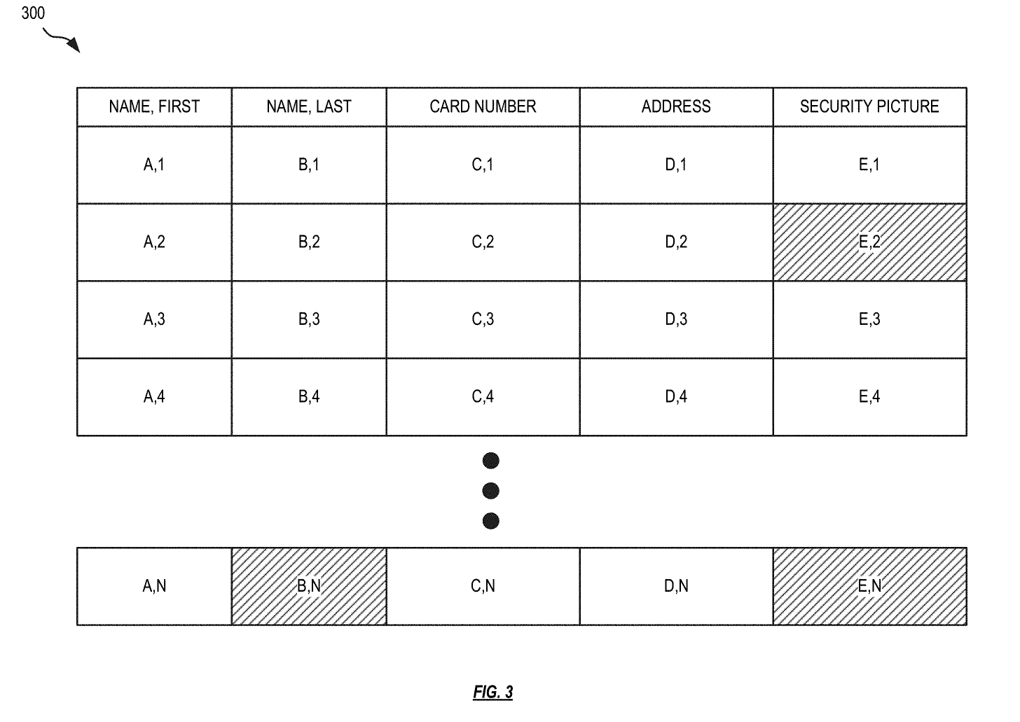

Referring to FIG. 1, the instructions 132 may be generated by authorizer 128 by comparing data access request 130 to a data decoder 138. FIG. 3 depicts a data decoder 300, which is an example of data decoder 138 of FIG. 1, in embodiments. As shown in FIG. 3, each location 204 is denoted in hashed shading. Upon receipt of data access request 130, authorizer 128 may compare the requested records within data access request 130 to the data decoder 138 and generate instructions 132 instructing authorized user device 104 to avoid the malware locations 204 (or mine data records 134, generally). It should be appreciated that data decoder 138 need not be a “map” or “table” as shown in FIG. 3. Alternatively, or additionally, data decoder 138 may be a listing of all mine data records 134, in embodiments. Alternatively, or additionally, data decoder 138 may be parameters of the mathematically generated function (e.g. the SAS Ranuni, Rannor, Ranbin, Ranpoi). It should be appreciated that data access request 130 may not be needed where authorized user 118 is pre-authenticated, such as logged onto a company IP server, and where the user 118 has prior knowledge to locations of the mine data records 134.

Data decoder 138 may be updated periodically as new records are generated in protected data 120. For example, as the database grows, additional mine data records 134 and standard data records 136 may be generated as well. Each time a new mine data record 134 is generated, data decoder 138 may be updated. Using a mathematically generated function (e.g. the SAS Ranuni, Rannor, Ranbin, Ranpoi) to generate the location of mine data records 134 is particularly advantageous when the data decoder 138 is located external to data storage device 102. This is because when the parameters of the mathematically generated function (e.g. the SAS Ranuni, Rannor, Ranbin, Ranpoi) are known, it can be automatically determined where the mine data records 134 will be based on the characteristics of the function itself. Therefore, as the protected data 120 grows, any external device (such as authorizer 128 located within network 110, or on authorized user device 104) need not constantly receive updates to data decoder 138 each time a new mine data record 134 is generated. Instead, the data decoder 138 automatically indicates where the mine data records 134 will be located because when the parameters of the mathematically generated function are known, the function (although it seems random) is not entirely random. As such, it may appear to a user (or computer not knowing the parameters of the function) that the mine data records 134 are located randomly, but in fact there is a non-random nature to the locations 204 of mine data records 134.

Using instructions 132, authorized user device 104 may then query data storage device 102, via network 110, and obtain downloaded records 140. Because instructions 132 indicate the locations 204 of mine data records 134, downloaded records 140 may only include standard data records 136, in embodiments. Alternatively, downloaded records 140 may include mine data records 134, but instructions 132 are configured to prevent authorized user device 104 from accessing mine data records 134 within the downloaded records 140.

The importance of instructions 132 is evident at least when fraudulent access to data storage device is obtained, for example, by a fraudulent user 142. Fraudulent user 142 may interact with fraudulent user device 106 to gain access to protected data 120. It should be appreciated that fraudulent user 142 may be a person, or may be a “bot” in that it is a computer program automatically trying to gain access to data storage device 102.

Fraudulent user device 106 may include a processor 144 in communication with a memory 146 and a network interface 148. Processor 144 may be any one or more computing device(s) capable of executing computer readable instructions. Memory 146 may be transitory and/or non-transitory, and capable of storing computer readable instructions and/or other data as discussed in further detail below. Memory 146 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory.

Fraudulent user device 106 may access network 110 via network interface 148. Network interface 148 may be 1) a wired communication protocol, such as telephone, Ethernet, fiber optics, Cable, USB, lighting cable, or other wired communication protocols, 2) a wireless communication protocol, such as WiFi, cellular 2G, 3G, 4G, 5G, LTE, or other wireless communication protocols, or 3) a combination of wired and wireless communication protocols.

Memory 146 may store a data miner 150. Data miner 150 may be computer readable instructions that, when executed by processor 144, attempt to gain access to protected data 120 via network 110. Data miner 150 may be, for example, malware that is uploaded to data storage device 102 to pull protected data 120 and thereby download protected data 120 to fraudulent user device 106 as downloaded data 152.

As the data miner 150 accesses protected data 120, because it has not received instructions (e.g. instructions 132) indicating where the mine data records 134 are located (e.g. locations 204, based on data decoder 138), downloaded data 152 will include mine data records 134.

Mine data records 134 may comprise computer readable instructions that, when accessed trigger (aka invoke, execute) malware that may implement one or more of the breach actions 154 described herein. In embodiments, malware may be parsed throughout multiple ones of the malware locations 204. In embodiments, as data miner 150 is fraudulently accessing protected data 120, mine data records 134 may be configured such that when all segments (or a given threshold number of segments) of the parsed malware located in different ones of the malware locations 204 are downloaded, the malware is automatically executed to implement a countermeasure including any of the breach actions 154 described herein.

In embodiments, the code implementing malware within mine data records 134 may be stored in a location 204. For example, the malware code may be stored within one or more image record (e.g. location 204(1)). An executable may be stored within another record (e.g. location 204(2)). As such, when the fraudulent user 142 attempts to access protected data 120, and particularly mine data record 134 at location 204(2) therein (or some other call-out (e.g. a record within mine data records 134 that invokes malware stored therein, but potentially at another location) within the mine data records 134), the malware stored within the image record is automatically executed thereby implementing breach action 154. As shown in FIG. 2, the call-out may be disguised as a particular type of category 202. For example, the call-out SMI'EX looks similar to the category 202(2) of “last name.” However, the “'EX” indicates that mine data record 134 at location 204(2) is actually a call-out. This call-out may then invoke malware stored within one or more mine data records 134 such as at locations 204(1) and/or 204(3). Further, using malware stored within image files, some of these images may be .pif files (e.g. a form of executable file) or .exe .bat, .cmd, .com, .cpl, .lnk, .msi, .reg, .vb, .vba, .vbs, .ws, .wsc, .wsf files; all of which are executable. These .pif files may be laden with malware. Windows software, as an example, runs .pif by using ShellExecute. ShellExecute automatically checks if the image is executable code. If it is executable code, then the executable code runs and the malware chain of events begins.

As such, the malware may be a self-extracting-and-executing archive (stored in one or more of the mine data records 134) from a virus installer and a .bat program opening an image to hide the virus' intent. Macros may be embedded within the mine data records 134 that may automatically trigger the execution of the .pif file under specific circumstances (incorrect password related, server location related, etc. or other indications that the data is in breach).

In embodiments, the breach action 154 may conduct a “SQL injection” that deletes data and/or shuts down the data storage device 102. In this embodiment, one or more mine data record 134 would dynamically construct a SQL statement (SQL code may have no distinction between data code and executable code). This functionally is accomplished by placing a meta-character into a line of the mine data record 134 itself, which enables the placement of SQL code in the control plane of the database that has misappropriated our data. The code below shows an example of using SQL injection:

### Example 1

Query: Select, CC_Nbr, Last, First from Master_Card

If the above query is an example of data access request 130, data storage device 102 would normally return, as an example:

524032940809234, Smith, John

However, if the query is implemented from fraudulent user device 106, some returned data may include mine data records 134, as an example:

52404328974324, Smi'ex, John

Smi′ex is not a last name. It's a call-out of an executable file named Smi (e.g. location 204(2)). The macro named “Smi” may be embedded in location 204(1) and/or 204(3). Access of Smi'ex would automatically invoke the macro names “Smi,” and therefore implement one or more breach actions 154 discussed herein.

It should be appreciated that additional or alternative breach actions 154 may be implemented without departing from the scope hereof. For example, in embodiments, breach action 154 may trigger a breach alert 156 which is then transmitted to one or more of data access portal 108 and authorized user device 104. Breach alert 156 may indicate that fraudulent user 142 (or a bot representation thereof) has attempted to access protected data 120. Breach alert 156 may additionally (or alternatively) call-out the location of fraudulent user device 106 to one or more of data storage device 102, authorized user device 104, and data access portal 108.

Moreover, breach action 154 may include a safeguard to prevent breach action 154 from being implemented on an authorized user device. For example, breach action 154 may be time-delayed such that an administrator (e.g. authorized user 118) may input a authentication code to prevent execution of malware within mine record data 134 if accidentally downloaded/accessed as part of downloaded records 140.

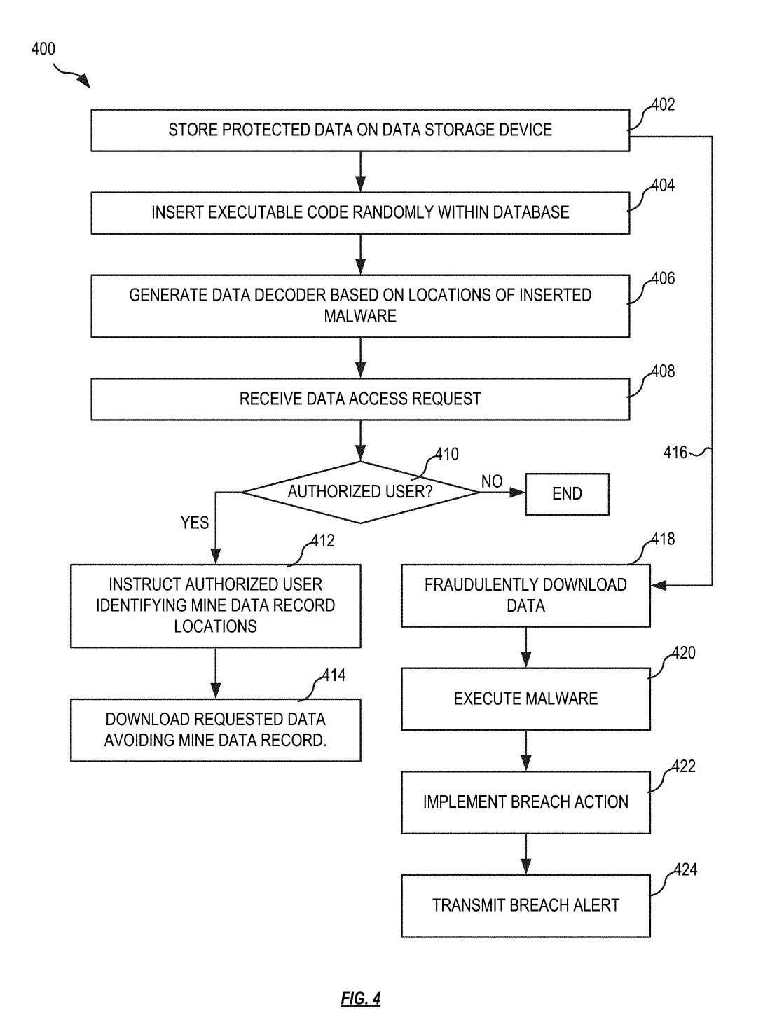

FIG. 4 depicts a method 400 for data theft prevention, in embodiments. Method 400 is, for example, implemented using system 100 as discussed above with respect to FIGS. 1-3.

In operation 402, method 400 stores protected data in a data storage device. In one example of operation 402, protected data 120 is stored within memory 114 of data storage device 102, which is accessible via local or remote connection through network 110.

In operation 404, method 400 inserts mine data records in the protected data from operation 402. In one example of operation 402, mine data records 134 are entered into protected data 120. It should be appreciated that any number of mine data records 134 may be included without departing from the scope hereof. In embodiments, mine data records 134 are generated randomly, periodically, or aperiodically. In embodiments, mine data records 134 are located at mathematically random locations (i.e. locations that appear completely random, but in fact are mathematically generated such as using the SAS Ranuni, Rannor, Ranbin, Ranpoi function and the location thereof may be identified based on knowledge of the function parameters).

In operation 406, method 400 generates a data decoder based on locations of the mine data records inserted in operation 404. In one example of operation 406, data storage device 102 generates data decoder 138 indicating locations of the mine data records 134.

In operation 408, method 400 receives a data access request. In one example of operation 408, data access request 130 is transmitted from authorized user device 104 to data access portal 108.

In operation 410, method 400 authenticates the originator of the data access request received at operation 408. In one example of operation 410, authorizer 128 authenticates authorized user device 104 and verifies that the authorized user 118 has permission to access data storage device 102. Operation 410 may be a decision. If the decision is a yes (e.g. the user is authenticated), then method 400 may proceed to operation 412; else, method 400 may end (or repeat at operation 402).

In operation 412, method 400, in response to receipt of the data access request, instructs authorized user regarding the identified mine data record locations. In one example of operation 412, instructions 132 are transmitted to authorized user device 104 including locations (e.g. locations 204) of each mine data record 134. Operation 412 may be performed prior to any receipt of data access request. For example, an authorized user 118 may receive instructions of locations 204 of all mine data records 134 upon logging onto a company website, or some other pre-registration procedure prior to the user attempting to access protected data 120 within the data storage device 102.

In operation 414, method 400 downloads requested data avoiding the mine data records. In one example of operation 414, authorized user device 104 accesses data storage device 102 via network 110 to obtain downloaded records 140. In operation 414, the downloaded data may or may not include mine data records 134. If the downloaded data includes the mine data records 134, then in operation 414 may include a sub-step of avoiding the mine data records 134 when the authorized user device 104 accesses the downloaded records 140.

At any time within the above described operations of method 400, the data stored in operation 402 may be breached by an unauthorized user, as indicated by arrow 416. For example, operation 418 of method 400 includes a fraudulent user downloading data from the data storage device. If operation 418 occurs, method 400 may include operation 420 which includes executing malware stored within the fraudulently accessed protected data. In one example of operation 420, malware stored within mine data records 134 is automatically executed based on access of the mine data records 134 by fraudulent user device 106. For example, the malware may be parsed throughout multiple locations (e.g. locations 204) and when all segments of the parsed malware are downloaded the malware is automatically executed to implement a countermeasure. In embodiments of operation 420, malware within mine data records 134 may include a call-out location in one mine data record 134 that executes code located within another mine data record 134.

In operation 422, method 400 implements a breach action. In one example of operation 422, breach action 154 is implemented in response to execution of malware within mine data records 134. In embodiments, operation 422 includes a safeguard operation (not shown) to prevent breach action 154 from being implemented on an authorized user device. For example, breach action 154 may be time-delayed such that an administrator (e.g. authorized user 118) may input an authentication code to prevent execution of malware within mine record data 134 if accidentally downloaded/accessed as part of downloaded records 140.

In operation 424, method 400 transmits a breach alert. In one example of operation 424, breach alert 156 is transmitted to one or more of data storage device 102, authorized user device 104, and data storage access portal 108.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for data theft prevention, comprising:
a data decoder, communicably coupled to a database having protected data therein, identifying mine data locations within the database, executable code being stored within the database at the mine data locations;
a network interface configured to provide access to the database from outside the database; and,
an authorizer including a processor and computer readable instructions that when executed by the processor:
verify a user device attempting to access the database as an authorized user device, and
when established as an authorized user device, instruct the authorized user device to avoid the mine data locations identified within the data decoder.

2. The system of claim 1, the mine data locations including an image associated with a data entry within the database.

3. The system of claim 1, the mine data locations including text associated with a data entry within the database, wherein the text is reformatted into an executable call-out.

4. The system of claim 1, an executable call-out being located in one of the mine locations, and the executable code being initiated by the executable call-out and being located in other of the mine data locations.

5. The system of claim 1, the executable code being parsed into a plurality of segments between multiple of the mine data locations.

6. The system of claim 5, the executable code being configured to execute when a threshold number of the plurality of segments of the executable code are accessed.

7. The system of claim 1, the executable code configured to send a breach alert when executed.

8. The system of claim 1, the executable code configured to delete the database when executed.

9. The system of claim 1, the executable code configured to delete all memory within a computer from which the executable code is downloaded.

10. The system of claim 1, wherein the data decoder is located in a separate device from the database.

11. The system of claim 1, the computer readable instructions of the authorizer being triggered in response to a data request from a user device.

12. A method for data theft prevention including,
storing protected data on a data storage device,
inserting executable code within the protected data at a plurality of mine data locations;
generating, via a processor executing computer readable instructions, a data decoder indicating the plurality of mine data locations; and,
instructing, via a processor executing computer readable instructions, an authorized user device requesting access to the protected data about the mine data locations such that when the authorized user device accesses the data storage device the authorized user device avoids the executable code.

13. The method of claim 12, the inserting executable code including inserting executable code in a first of the mine data locations, and a call-out for initiating said executable code in a second of the mine data location of the protected data.

14. The method of claim 12, the inserting executable code including parsing the executable code between the plurality of mine data locations.

15. The method of claim 13, the inserting executable code including selecting the plurality of mine data locations randomly.

16. A data storage device, comprising:
protected data including a plurality of mine data records and a plurality of standard data records;
executable code located at the plurality of mine data records that, when executed, implement a breach action;
locations of the plurality of mine data records being recorded in a data decoder accessible by an authorized user to prevent access of the executable code by the authorized user.

17. The data storage device of claim 16, the breach action including erasing data at a device external to the data storage device.

18. The data storage device of claim 16, the breach action initiating a breach alert sent to a device external the data storage device.

19. The data storage device of claim 16, the executable code, when implemented, initiating a safeguard procedure allowing an authorized user device to prevent execution of the executable code.

20. The data storage device of claim 16, the locations of the plurality of mine data records being selected based on a random function.
